(19) United States
(12) Patent Application Publication
(10) Pub. No.: US 2024/0344213 A1
(43) Pub. Date: Oct. 17, 2024

(54) Electrolysis System

(71) Applicant: Ceres Intellectual Property Company Limited, Horsham West Sussex (GB)

(72) Inventors: Joshua Ryley, Horsham West Sussex (GB); Joao Claudio Buzatti Vianna, London (GB)

(21) Appl. No.: 18/294,427

(22) PCT Filed: Jul. 27, 2022
(86) PCT No.: PCT/GB2022/051965

§ 371 Date: Feb. 1, 2024

(30) Foreign Application Priority Data
Aug. 6, 2021 (GB) 2111411.1

(51) Int. Cl. C25B 9/73; C25B 1/042; C25B 1/23; C25B 9/67; C25B 15/021; C25B 15/08

(52) U.S. Cl. CPC C25B 9/73; C25B 9/67; C25B 15/021; C25B 15/08; C25B 1/042; C25B 1/23

(57) ABSTRACT

A solid oxide electrolyser cell system includes an electrolysis stack comprising an anode, a cathode and a solid-oxide electrolyte. The anode comprises an anode inlet. The system comprises a sweep gas supply for supplying a sweep gas to the anode via the anode inlet, and a sweep gas supply flow path defining a flow path between the sweep gas supply and the anode inlet. The system comprises a first heat exchanger in communication with the sweep gas supply flow path. The first heat exchanger communicates with a stream having a source external to the system and defining an external stream flow path. The first heat exchanger exchanges heat between the sweep gas supply flow path and the external stream flow path. An example method of operating such a system includes exchanging heat between the external stream flow path and the sweep gas supply flow path through the first heat exchanger.

### FIELD

The present invention relates to an electrolysis or electrolyser system for producing hydrogen (or syngas) via electrolysis of water (and carbon dioxide) in a cell equipped with an electrolyte. One such form of cell is a solid oxide electrolyser cell, or SOEC.

### BACKGROUND

Electrolysis systems generally comprise one or more cell with the electrolyte, an anode and a cathode, and they operate to produce hydrogen by electrolysis of water or syngas by electrolysis of water and carbon dioxide.

For producing hydrogen, the cell is supplied with water—in the form of steam—at the cathode, and a reducing gas or fuel is supplied to the anode. A DC electric current is then provided across the anode and the cathode. The water (steam) will then be subjected to reduction such that the steam is reduced to hydrogen gas and oxygen, with the oxygen electrochemically converting the fuel across the electrolyte to provide an exhaust gas on the anode side, and the hydrogen being output as a gas on the cathode side.

A characteristic of electrolyser systems is that they tend to be energy inefficient. Much of this is due to the fact that they most effectively operate at temperatures well above room temperature-usually between 50° and 800° C. To achieve these temperatures at start up, they generally use heaters to warm up the system to an operating temperature, typically by heating the input fluid streams (high temperature steam and high temperature fuel). They also need to maintain that fluid supply at elevated temperatures during the operation of the system to maintain the efficient operation of the electrolyte. Furthermore, they vent the off-gases (the exhaust gas and the hydrogen) at high temperature, which again wastes energy.

Prior art systems are known that use a heat exchanger to utilise the heat of the exhaust gas to heat up the steam prior to inputting that steam into the cathode side. See for example, US2007217995A1 and US2009235587. However, this has the disadvantage that the exhaust gas is only produced when the system is running. Therefore, there is a lack of available heat during start-up.

Therefore, the present invention seeks to utilise heat flow paths more efficiently, such as during start-up, during operation and during cool down. The present invention also seeks to enhance the operational efficiency of an electrolyser system.

### SUMMARY

According to the present invention there is provided a solid oxide electrolyser cell system comprising:
an electrolysis stack comprising an anode, a cathode and a solid-oxide electrolyte, the anode comprising an anode inlet,
a sweep gas supply for supplying a sweep gas to the anode via the anode inlet,
a sweep gas supply flow path defining a flow path between the sweep gas supply and the anode inlet.
a first heat exchanger in fluid communication with the sweep gas supply flow path,
wherein the first heat exchanger is also in fluid communication with a fluid stream having a source external to the solid oxide electrolyser cell system and defining an external stream flow path, and
the first heat exchanger is configured to exchange heat between the sweep gas supply flow path and the external stream flow path.

An external stream flow path can be available from various sources. The external stream flow path is external to the operation of the solid oxide electrolyser cell system. Therefore, it is a separate process. This heat may otherwise be wasted or not utilized. By using the stream to heat the sweep gas supply flow path, this increases efficiency of the electrolysis stack. The heat from the external stream can be of any grade. Low grade heat, for example, less than 200° C., can be used.

The use of an external stream can be particularly useful during start-up of the electrolyser system where the electrolysis stack is producing no or very little heat. Therefore, the external stream provides a level of heat to the sweep gas supply flow path and thus the anode inlet to increase start-up efficiency and reduce any heat supplied from other sources, e.g. heaters.

Preferably, the system comprises a bypass flow path connected to the sweep gas supply flow path, the bypass flow path connected at its first end to a position upstream of the first heat exchanger, and the bypass flow path connected at its second end to a position downstream of the first heat exchanger.

A bypass flow path allows the diversion of the sweep gas supply flow path around the external stream flow path connected to the first heat exchanger. Therefore, the flow can be directed toward the anode inlet without heat exchange. This may be of use where the transfer of heat from the external fluid stream would be insufficient to heat the sweep gas supply flow path. In some cases, the external heat source may not be operating and therefore heat exchange with the external stream may wish to be avoided as this will reduce the temperature of the sweep gas supply flow path.

Furthermore, the bypass flow path can be utilised if the maximum possible heat recovery for the part limitations is exceeded, for instance in the heat exchangers. Therefore, the bypass flow path can be used to avoid damage to the system.

Preferably, the system comprises a first heater positioned in the sweep gas supply flow path and connected downstream of the first heat exchanger. Such a first heater can provide fine-tuning for the heating of the sweep gas supply in the sweep gas inlet flow path. In particular, after the heat exchange with the external fluid stream, the amount of additional heat desired for the anode inlet will vary. The first heater can trim the heat provided. The amount of heat energy provided by the first heater can be reduced as necessary given the other sources of heat, thus increasing the overall efficiency of the system.

Preferably, the first heater is an electrical heater or a combustion heater. This heater may also be referred to as a trim heater. The first heater can be referred to as the inlet heater or the sweep gas heater.

Preferably, the first heater is positioned after the bypass flow path. This allows the first heater to heat the sweep gas supply flow path when required and not be bypassed. Instead, the heater can be controlled to supply the required level of heat energy or, when not required, to cease supplying heat. The degree of heat supplied can also be varied.

The sweep gas can be any number of gases, such as CO2, O2, N2, Ar, etc. The sweep gas can also be air. Generally, any gas that does not react with Oxygen can be used as a sweep gas. The sweep gas can be called a reducing gas.

Preferably the system comprises:
an anode outlet for the anode of the electrolysis stack comprising.
an anode outlet flow path defining a flow path between the anode outlet and a first exhaust, and
a second heat exchanger in fluid communication with the sweep gas supply flow path and positioned downstream of the first heat exchanger in the sweep gas supply flow path, the second heat exchanger also in fluid communication with the anode outlet flow path, wherein the second heat exchanger is configured to exchange heat between the sweep gas supply flow path and the anode outlet flow path.

As a result of the electrolysis reaction in the stack, an exhaust gas is formed and output through the anode outlet. This exhaust gas is then exhausted out of an exhaust, i.e. the first exhaust. However, the exhaust gas contains energy in the form of heat. An exhaust gas may have a temperature in the region of 500° C. to 650° C. Therefore, it would also be beneficial to use this heat. The second heat exchanger provides a further means of heating the sweep gas supply flow path.

The second heat exchanger is downstream of the first heat exchanger. Where the exhaust gas has a higher temperature than the external source flow stream, such as during full operation after warm-up, the temperature of the sweep gas supply flow path is to be increased prior to reaching the anode inlet. The sequential heating via heat exchangers increases the system efficiency.

Preferably, in some embodiments, the first heat exchanger is arranged downstream of the second heat exchanger. This can be advantageous where the external stream is particularly high-grade heat and therefore the increase in the order of heat exchange is preferred.

The bypass flow path can also bypass the second heat exchanger. Therefore, the sweep gas supply flow path does not pass through the first heat exchanger or the second heat exchanger. This can be of use during start-up where the anode exhaust gas temperature can be lower than the sweep gas supply temperature. As previously discussed, it can also be of use to protect components where the part limitations might be exceeded

The terms low-grade and high-grade heat are used to describe a quality or level of heat in a flow path. Where a process produces heat as a by-product, this can be referred to waste heat and is often classified according to temperature as low-grade, medium-grade and high-grade. Other terms, such as waste heat or secondary heat are also used. For the purposes of the present explanation, it is considered that low-grade heat is in the region of 150° C. to 300° C., however, lower temperature can be utilised. The term high-grade heat is also used and is to mean a temperature in the region of 500° C. and above. However, for purposes of this explanation, temperatures above 350° C. can also be considered high-grade.

In some embodiments, it is preferable for the bypass flow path to bypass only the first or the second heat exchanger.

Preferably, the system further comprises:
a cathode inlet for the cathode of the electrolysis stack,
a fuel supply for supplying fuel to the cathode via the cathode inlet,
a fuel supply flow path defining a flow path between the fuel supply and the cathode inlet,
a cathode outlet for the cathode of the electrolysis stack,
a cathode outlet flow path defining a flow path between the cathode outlet and a second exhaust, and
a third heat exchanger in fluid communication with the fuel supply flow path downstream, the third heat exchanger also in fluid communication with the cathode outlet flow path, and configured to exchange heat between the fuel supply flow path and the cathode outlet flow path.

Due to the electrolysis reaction in the stack, a hydrogen gas (or in some cases a syngas) is formed and output through the cathode outlet. This can be referred to as the product, product gas or fuel. The product is then passed to an exhaust and used for various other processes. The product at the cathode outlet has high grade heat energy, in the region of 500° C. to 650° C. Therefore, the heat from this can be used for also heating up the sweep gas inlet flow path. This ensures that high temperature steam is supplied to the cathode inlet.

Preferably, the system comprises a cathode outlet branch flow path connecting the cathode outlet flow path and the anode outlet flow path placing them in fluid communication.

It is advantageous to have a cathode outlet branch flow path connecting to the anode outlet flow path to also provide heat energy for transfer in the second heat exchanger. This branch flow path allows a partial flow of the product from the cathode outlet flow path to the anode outlet flow path to the first exhaust.

Preferably, the system comprises a valve arranged in the cathode outlet branch flow path. The valve allows control of the flow of the product gas to the anode exhaust. In particular, it may only be advantageous to use the branch flow path during start-up where an increase of the temperature of the sweep gas supply flow path is required.

Preferably, the system comprises a fourth heat exchanger in fluid communication with the fuel supply flow path and also in fluid communication with the external stream flow path and configured to exchange heat between the flow paths.

The fuel supply is connected to the cathode inlet for the electrolysis reaction in the stack. The fuel supply is normally water or, more precisely, steam. It is advantageous to heat the fuel supply path for a more efficient electrolysis reaction in the stack. Furthermore, this ensures that the water is heated to level to provide steam. Therefore, by using the external stream flow path to also heat the fuel supply, the low grade heat can be utilised for both flow paths to the anode and cathode inlets. The external stream flow path can be split for this purpose having one path for the first heat exchanger and one path for the fourth heat exchanger.

Preferably, the external stream flow path for the fourth heat exchanger is a different/second flow path for supplying the fourth heat exchanger to that supplying the first heat exchanger.

Preferably, the third heat exchanger in fluid communication with the fuel supply flow path is downstream of the fourth heat exchanger in this flow path. The third heat exchanger is in fluid communication with the cathode outlet flow path, and configured to exchange heat between the fuel supply flow path and the cathode outlet flow path.

As previously discussed, the output from the cathode outlet has high-grade heat when the stack is in full operation. This heat can be used to also heat the fuel supply flow path. This ensures that high temperature steam is supplied to the cathode inlet. The fourth heat exchanger can be in addition to the third heat exchanger. Alternatively, the third and fourth heat exchanger can form separate embodiments. Likewise, the third and fourth heat exchangers can be in a system that does not include a branch flow path connecting the cathode outlet flow path to the anode outlet flow path.

Preferably, in some embodiments, the fourth heat exchanger is downstream of the third heat exchanger in the fuel supply flow path. This can be advantageous where the external stream flow path is of high grade heat.

Preferably, the system comprises a second heater positioned in the fuel supply flow path arranged downstream of the third heat exchanger in this flow path. Preferably, the second heater is arranged downstream of the fourth heat exchanger. Such a second heater can provide fine-tuning for the heating of the fuel supply in the fuel supply flow path. In particular, after the heat exchange with either or both the third and fourth heat exchangers, the amount of heat required for the cathode inlet will vary. The second heater can trim the heat provided. This can also provide energy efficiency as the heat provided by the second heater can be reduced where it is not required. The second heater can be referred to as a (further) inlet heater or a fuel supply heater.

Preferably, the second heater is an electrical heater or a combustion heater.

Preferably, the system comprises a third heater positioned in the anode outlet flow path between the anode outlet and the second heat exchanger. The third heater allows the heating of the anode outlet flow path to increase the heat exchanged with the sweep gas supply flow path. A third heater in this flow path can be particularly useful during start-up where the anode exhaust gas will have a lower level of heat energy.

The burner is a combustion heater or electrical heater. It can also be referred to as a stack outlet heater, anode exhaust gas heater, or burner. Preferably, a fuel supply is provided to the third heater when it is combustion heater.

Preferably, the third heater is fed by an external fuel supply. The anode exhaust gas may not be combustible. Therefore, an external fuel can be provided to the burner to heat the anode exhaust gas to allow heat exchange with the sweep gas supply flow path. This is particularly advantageous during start-up or heat-up of the stack.

Where the branch flow path is provided, this is preferably connected to the third heater. The cathode outlet gas is a combustible gas. e.g. hydrogen or syngas, and this can be combusted in the burner. This will heat up the anode outlet flow path for heating the sweep gas supply flow path at the second heat exchanger. This can be used at start-up. In such a case, the valve arranged in the branch flow path can be opened to allow the flow of the product gas from the cathode outlet to the burner. This may be useful where the exhaust gas from the anode outlet is low grade, such as during start-up or heat-up of the stack.

Preferably, the system comprises a diverter valve connected in the anode outlet flow path at a position between the anode outlet and the second heat exchanger, the diverter valve also connected to the external stream flow path and a third exhaust, and the diverter valve configured to direct a flow between the anode outlet and the second heat exchanger, external stream flow path or the third exhaust.

Instead of the previously discussed path of the anode outlet flow path to the second heat exchanger, the diverter valve allows an exhaust gas from the anode outlet to be diverted to a third exhaust that does not pass through the heat exchanger. This can be useful for cool down of the system. In such a situation, heat recuperation, e.g. through the second heat exchanger, is not required. Therefore, the diverter valve allows the hot gas to be vented elsewhere. i.e. through the third exhaust. This can also be useful for where the heat limitations of the heat exchangers would be exceeded by the temperature of the exhaust gases. Therefore, the gas is vented prior to the second heat exchanger.

The diverter valve can also connect to the external stream flow path. The external stream flow path can have branching flow path for this purpose. This can allow a flow of the low grade heat from the external source to the anode outlet flow path. This can be useful during start-up to heat up the stream to reduce the energy input into the stream. This is particularly the situation where the external stream is warmer than the anode outlet flow path. This can also be of benefit when the external source provides a combustible gas allowing combustion of this gas in the third heater to generate heat for the sweep gas supply flow path. The flow can be in either direction. e.g. toward the anode outlet or toward the second heat exchanger, as required.

Preferably, the third heater can be connected to diverter valve where present. The third heater is positioned between the second heat exchanger and the diverter valve.

Preferably, where a branch flow path is present, this can be connected to the anode outlet flow path that is connected to the diverter valve.

Such a configuration allows a large degree of adaptability for the movement of flows and heat around the system. In particular, during start-up heat can be provided to the sweep gas supply flow path from various sources. Likewise, during cool down, there are also options for venting heat through the third exhaust.

In accordance with the present invention, there is also provided a method of operating a solid oxide electrolyser cell system comprising:
providing a sweep gas supply for supplying a sweep gas to an anode of an electrolysis stack via an anode inlet, and defining an sweep gas supply flow path between the sweep gas supply and the anode inlet,
providing a fluid stream having a source external to the solid oxide electrolyser cell system, and defining an external stream flow path from the fluid stream, and
exchanging heat between the external stream flow path and the sweep gas supply flow path through a first heat exchanger.

By using the external fluid stream to heat the sweep gas supply flow path it increases efficiency of the electrolysis stack. This can be particularly useful during start-up where the system temperature is low and heat energy cannot be recuperated from internal means.

Preferably, the method of operating a solid oxide electrolyser cell system defines an anode outlet flow path between an anode outlet of the anode of the electrolyser and a first exhaust to the system.

Preferably, the method of operating a solid oxide electrolyser cell system comprises exchanging heat between the anode outlet flow path and the sweep gas supply flow path by a second heat exchanger, the second heat exchanger arranged in the sweep gas supply flow path at a position downstream of the first heat exchanger.

When there is sufficient heat to do so, the exhaust gas from the stack can also be used to heat the sweep gas supply flow path. This recuperating heat exchanger will depend on the grade of heat available from the stack. This will reduce the requirement to provide heat to the sweep gas supply flow path from other sources.

Preferably, the method of operating a solid oxide electrolyser cell system comprises bypassing the first and second heat exchangers by a bypass flow path arranged in the sweep gas supply flow path upstream of the first heat exchanger and downstream of the second heat exchanger. This allows the bypassing of the heat exchanger when there is insufficient heat to exchange, such as from the external stream flow path or from the anode outlet flow path.

Preferably, the method of operating a solid oxide electrolyser cell system comprises providing heat to the anode outlet flow path from a third heater arranged in the anode outlet flow path between the anode outlet and second heat exchanger. This can be beneficial where the heat produced from the anode outlet requires additional heat to exchange with the sweep gas supply flow path. Situations where this can occur include the start-up where the stack is not producing high-grade heat.

Preferably, the method of operating of operating a solid oxide electrolyser cell system comprises providing heat to the anode outlet flow path from the external fluid flow path or the third heater by a diverter valve arranged in the flow paths between the anode outlet and the burner. There are situations, such as during cool down, where it is not desirable to exchange heat with the sweep gas supply flow path. Therefore, a diverter valve can direct the heat from the anode outlet to another path, such as an exhaust. This will increase the rate of cool down of the system.

### BRIEF DESCRIPTION OF THE DRAWINGS

These and other features of the present invention will now be described in further detail, purely by way of example, with reference to the accompanying drawings, in which:

FIG. 1 shows a schematic of an electrolyser system with an external stream flow path for an anode side of the stack;

FIG. 2 shows the schematic of FIG. 1, including a third heater in an anode exhaust gas flow path:

FIG. 3 shows the schematic of FIG. 1, where the external stream flow path is provided at a different location:

FIG. 4 shows the schematic of FIG. 1, where an external stream flow path is provided for a cathode side of the stack:

FIG. 5 shows the schematic of FIG. 4, where the external stream flow path is provided at a different location:

FIG. 6 shows the schematic of FIG. 2, including a diverter valve; and

FIG. 7 shows a schematic of an electrolyser system similar to that of FIG. 1, where the external stream flows of the cathode and anode side are the same.

### DETAILED DESCRIPTION

Reference now will be made in detail to the embodiments of the invention, one or more examples of which are set forth below. Each example is provided by way of explanation of the invention, not limitation of the invention.

A list of the reference signs used herein is given at the end of the specific embodiments.

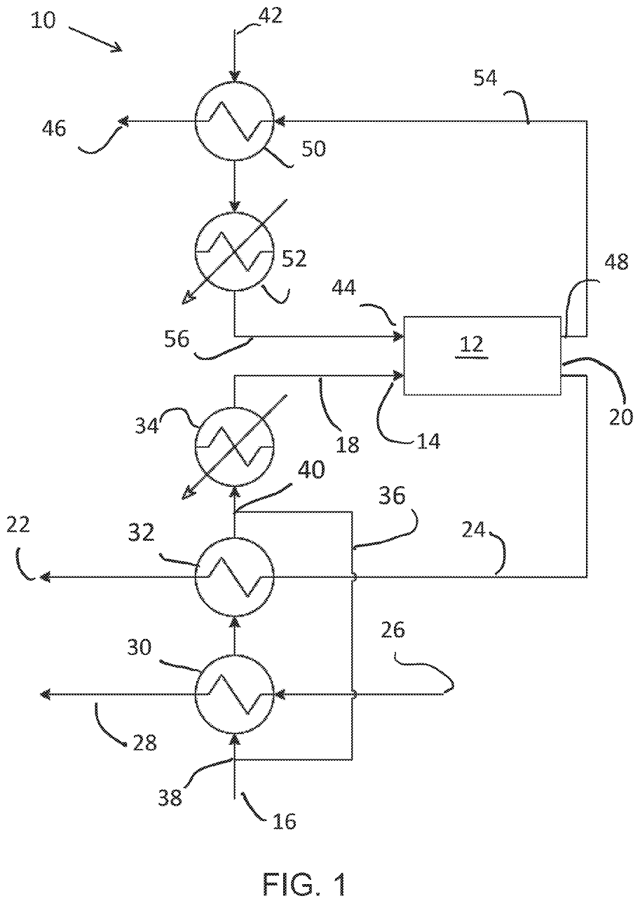

Referring to FIG. 1, an electrolyser system 10 is shown. The electrolyser system 10 comprises generally an electrolysis stack 12. An electrolysis stack 12 comprises generally of an anode and cathode for the purposes of a reduction reaction to produce a product.

The stack 12 has an anode inlet 14 through which a supply is provided to the anode of the stack 12. A sweep gas supply 16 is provided and this is connected to the anode inlet 14 by a sweep gas supply flow path 18.

Whilst flow paths will be referred to, generally a flow path is a flow that passes through a pipe or line from one position to another. Therefore, it defines a fluid connection or fluid communication between points. Whilst the sweep gas supply flow path 18 is discussed, it is also a sweep gas supply pipe or line 18 and provides fluid communication. For consistency, flow paths will be referred to where possible.

Generally, sweep gas is provided through the sweep gas supply 16 and passes through the sweep gas supply flow path 18 to the anode inlet 14.

The stack 12 comprises an anode outlet 20, wherein an exhaust product is expelled through the anode outlet 20. This is generally an exhaust gas. The anode outlet 20 is connected to a first exhaust 22 by an anode outlet flow path 24. Thereby an exhaust gas produced in the stack 12 is expelled at the anode outlet 20 and passes through the anode outlet flow path 24 to the first exhaust 22.

The exhaust gas can be utilised for various purposes outside of the system 10.

Entering the electrolyser system 10 is an external fluid stream 26. The external fluid stream 26 is a stream that is produced separate from the process of the electrolyser system 10. The external fluid stream 26 can be a hot flow of fluid or gas.

Whilst it is expected that the external fluid stream 26 will be an exhaust gas from another process and is of low-grade heat (e.g. around 200° C.), different sources can be utilised to provide the external fluid stream 26 with higher or lower grades of heat.

The external fluid stream 26 forms an external stream flow path 28. The external stream flow path 28 passes through a first heat exchanger 30. The first heat exchanger 30 is also arranged in the sweep gas supply flow path 18 between the sweep gas supply 16 and the anode inlet 14. Therefore, the external stream flow path 28 and the sweep gas supply flow path 18 both pass through the first heat exchanger 30 and exchange heat in the first heat exchanger 30.

As discussed, the external fluid stream 26 and thus external stream flow path 28 is expected to contain heat energy. Therefore, where the sweep gas supply flow path 18 has less heat, the heat is transferred in the first heat exchanger 30 to the sweep gas supply flow path 18 prior to entering the stack 12. This can be beneficial as a high temperature sweep gas supply 16 at the anode inlet 14 is preferred for the electrolyser reaction in the electrolysis stack 12.

In some situations, the sweep gas supply flow path 18 is of higher temperature than the external stream flow path 28. Therefore, the transfer of heat in the first heat exchanger 30 would be from the sweep gas supply flow path 18 to the external stream flow path 28. It is expected that this would be generally undesirable, unless the temperature of the sweep gas supply flow path 18 was to be reduced for cooling the stack 12 and system 10 for instance.

The use of an external fluid stream 26 to provide heat to the system 10 and more particularly the sweep gas supply flow path 18 is beneficial as it does not rely on any process within the system 10 to provide heat to the sweep gas supply flow path 18 or other parts of the system 10. In particular, when the system 10 is in start-up, the electrolyser reaction in the electrolysis stack 12 would not be generating any/much heat. Therefore, the external fluid stream 26 can provide heat energy independently to the system 10 and does not depend on the operational status of the system 10.

It is also shown in FIG. 1 that the anode outlet flow path 24 passes through a second heat exchanger 32 before passing onto the first exhaust 22. This second heat exchanger 32 is also arranged in the sweep gas supply flow path 18. The second heat exchanger 32 is arranged in the sweep gas supply flow path 18 between the first heat exchanger 30 and the anode inlet 14. Therefore, the anode outlet flow path 24 and the sweep gas supply flow path 18 exchange heat in the second heat exchanger 32.

The anode outlet flow path 24 can carry the exhaust gas from the anode outlet 20. The exhaust gas from the anode outlet 20 can contain heat energy. In particular, during operation of the system 10, the exhaust gas may contain high-grade heat (e.g. around 550° C.). Therefore, the heat from the exhaust gas can be used to heat the sweep gas supply flow path 18 in the second heat exchanger 32. This is beneficial to provide sweep gas at the anode inlet 14 of high temperature to increase efficiency of the electrolysis reaction in the stack 12.

A first heater 34 is provided in the sweep gas supply flow path 18. This is positioned between the second heat exchanger 32 and the anode inlet 14. The first heater 34 is used for heating the temperature of the sweep gas supply 16 in the sweep gas supply flow path 18. The first heater 34 can be an electric heater or a combustion heater as required. The first heater 34 provides additional heating to the sweep gas supply flow path 18 as required. This can be referred to as an inlet heater or a sweep gas heater.

In situations where there is high heat transfer at the first and second heat exchangers 30, 32, the amount of heat energy supplied at the first heater 34 can be low. Whereas where there is low heat transfer at the first and second heat exchangers 30, 32, the heat energy supplied at the first heater 34 is high. This can be of benefit during start-up where the system 10 is not producing much heat energy in the electrolyser reaction in the electrolysis stack 12.

The first heater 34 is also referred to as a trim heater as it provides small amounts of heat for fine-tuning the temperature at the anode inlet 14 to ensure a consistent and efficient electrolyser reaction in the stack 12.

A bypass flow path 36 is shown connecting to the sweep gas supply flow path 18. The bypass flow path 36 is connected at its first end 38 at a point on the sweep gas supply flow path 18 between the sweep gas supply 16 and the first heat exchanger 30. Therefore, the first end 38 is upstream of the first heat exchanger 30. The bypass flow path 36 is connected at its second end 40) at a point between the second heat exchanger 32 and the first heater 34. Therefore, the second end is downstream of the second heat exchanger 32.

The bypass flow path 36 bypasses the first and second heat exchanger 30, 32. This can allow for the sweep gas supply flow path 18 to avoid any heat exchange with the heat exchangers. This can be beneficial where the heat energy in the external stream flow path 28 and/or the anode outlet flow path 24 is of a level that is not required for the sweep gas supply flow path 18. Such situations can include start-up where the flow paths might be cold, or during cool down, where transfer of heat to the sweep gas supply flow path 18 is no longer required and the sweep gas supply 16 is being used to cool the system 10.

The bypass flow path 36 is operable by a control valve or the like. The control valve can be a mechanical or electrical control valve set to a certain setting to open or close, or can be manually operated. A controller, i.e., including a processor and memory, can be programmed to operate the control valve in certain situations as required.

Whilst the above are presented as shown in FIG. 1, it is highlighted that certain variations can be made. In particular, the presence of the first heat exchanger 30, the second heat exchanger 32, the first heater 34 and the bypass flow path 36 can be varied as required for the function of the system 10. For instance, a second heat exchanger 32 may not be required in some situations, such as where the external fluid stream 26 is high grade heat.

A fuel supply 42 is provided and is connected to a cathode inlet 44 provided on the electrolysis stack 12. The cathode inlet 44 being the inlet to the cathode of the electrolysis stack 12. The connection therebetween is a fuel supply flow path 56 and provides a flow, pipe or line for the fuel to pass into the system 10 at the fuel supply 42 to the cathode inlet 56.

The electrolysis stack 12 also comprises a cathode outlet 48 that is the outlet from the cathode of the electrolysis stack 12. The cathode outlet 48 is connected to a second exhaust 46 by a cathode outlet flow path 54.

The electrolyser reaction in the stack 12 requires a fuel, provided at the fuel supply 42 and passes to the electrolysis stack 12 at the cathode inlet 44. The fuel is generally water or steam and it is at the cathode that the product of the reaction is produced, that is generally hydrogen. Therefore, it is hydrogen that is output at the cathode outlet 48 and passed to the second exhaust 46 via the cathode outlet flow path 54. The output of the second exhaust 46 will be captured for use in the required process.

In FIG. 1, there is provided a third heat exchanger 50 in the fuel supply flow path 56 between the fuel supply 42 and the cathode inlet 44. The cathode outlet flow path 54 is also connected to the third heat exchanger 50 between the cathode outlet 48 and the second exhaust 46 of the cathode outlet flow path 54. Therefore, heat is exchanged between the cathode outlet flow path 54 and the fuel supply flow path 42.

The product, e.g. hydrogen, produced in the stack 12 and output at the cathode outlet 48 can be of high heat energy (e.g. around) 550°. Therefore, this heat energy can be used to heat the fuel supply flow path 56. This can be beneficial as it is preferred that steam is used for the electrolyser reaction and thus the fuel is to have high heat energy. Therefore, heat energy can be transferred from the cathode outlet flow path 54 to the fuel supply flow path 56 in the third heat exchanger 50. This heat exchanger 50 can be referred to as a recuperating heat exchanger.

This can also be beneficial as the product, e.g., hydrogen, at the second exhaust 46 is preferred to be lower in heat energy for exporting to other processes. Therefore, the transfer of heat from the product is beneficial.

A second heater 52 is provided on the fuel supply flow path 56 for heating the flow path. The second heater 52 is positioned between the third heat exchanger 50 and the cathode inlet 44. Therefore, the second heater 52 is downstream of the fuel inlet 42. The second heater 52 is similar to the first heater 34 in that it can be an electric heater or a combustion heater as required. The second heater 52 provides additional heating to the fuel supply flow path 56 as required.

In situations where there is high heat transfer at the third heat exchanger 50, the amount of heat energy supplied at the second heater 52 can be low. Whereas where there is low heat transfer at the third heat exchanger 50, e.g. during start-up, the heat energy supplied at the second heater 52 can be high. This can be of benefit during start-up where the system 10 is not producing much heat energy in the electrolyser reaction in the electrolysis stack 12.

The second heater 52 is also referred to as a trim heater for the same reasons as the first heater 34 as it provides small amounts of heat for fine-tuning the temperature at the cathode inlet 44 to ensure a consistent and efficient electrolyser reaction in the stack 12.

The addition of the third heat exchanger 50 and the second heater 52 is optional and each of these can be varied with other components, such as the first heat exchanger 30, the second heat exchanger 32, the first heater 34 and the bypass flow path 36 as required for the desired function and efficiency of the system 10

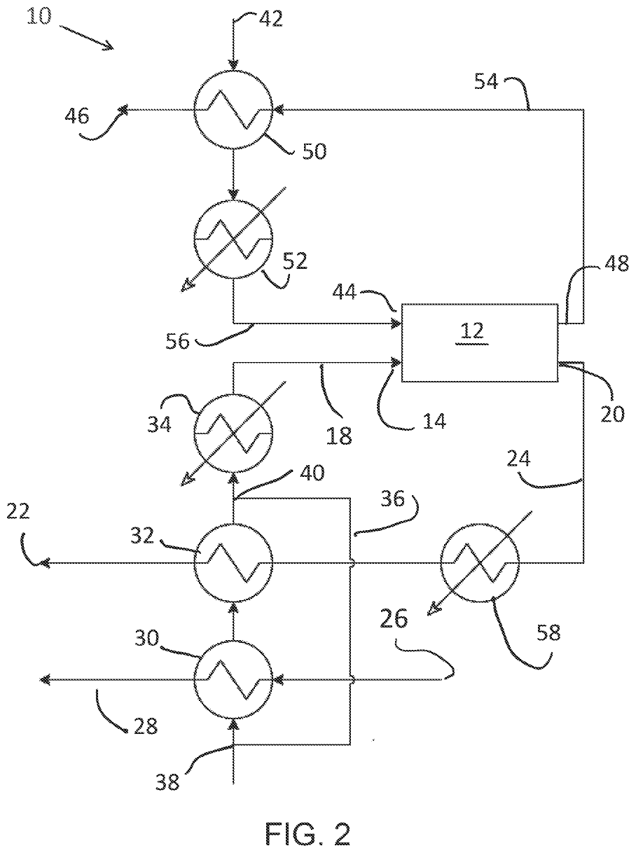

Referring to FIG. 2, there is provided an electrolyser system 10 as shown in FIG. 1. However, in addition, there is provided a third heater 58 in the anode outlet flow path 24. The third heater 58 is positioned in the anode outlet flow path 24 between the anode outlet 20 and the second heat exchanger 32.

The third heater 58 is an electrical or combustion heater that is provided to heat the anode exhaust gas in the anode outlet flow path 24. This can be beneficial to provide additional heating for the sweep gas supply flow path 18, such as when the anode exhaust gas has low-grade heat. e.g. during start-up or warm-up.

The third heater 58 can also heat the anode outlet flow path 24 between the anode outlet 20 and the third heater 58. This can be achieved by a reverse flow passing through the anode outlet flow path 24. The reverse flow can be provided from the external fluid stream 26, for instance. Therefore, the external stream flow path 28 can be heated by the third heater 58. The heating of the anode outlet flow path 24 using a reverse flow to the anode outlet 20 can be useful for heating the system 10 and the stack 12 during start-up and prior to operation.

During full operation, the third heater 58 may not be required where the anode exhaust gas at the anode outlet 20 is of high temperature. Therefore, the requirement to heat the anode outlet flow path 24 by the third heater 58 is reduced. The third heater 58 may also be controlled to provide varied heating to the anode outlet flow path 24, as required.

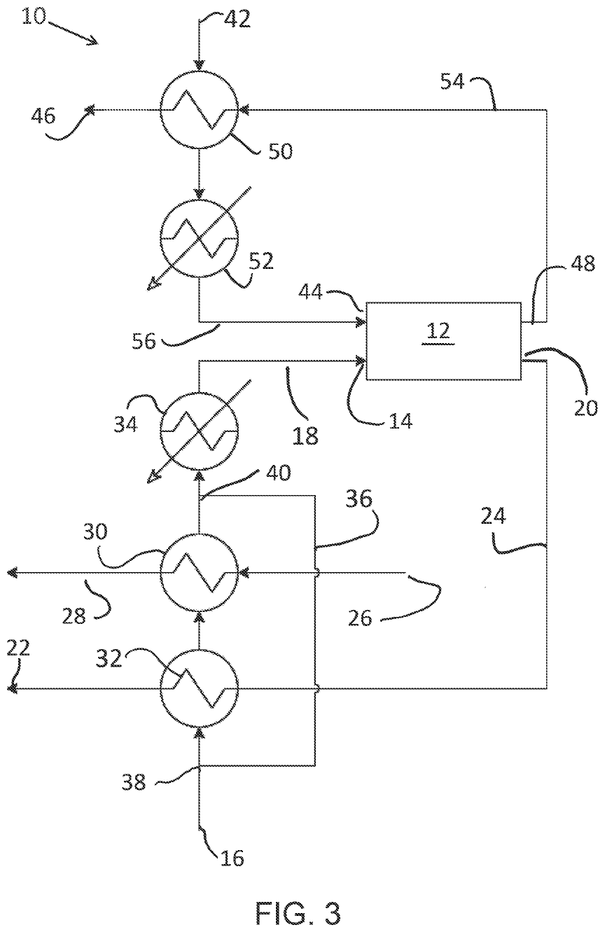

Referring to FIG. 3, there is provided an electrolyser system 10 as shown in FIG. 1. However, in FIG. 3, the position of the first heat exchanger 30 has been reversed with that of the second heat exchanger 32. That is to say that the second heat exchanger 32 is positioned upstream of the first heat exchanger 30, and the second heat exchanger is positioned between the sweep gas inlet 16 and the first heat exchanger 30, and the first heat exchanger is positioned between the second heat exchanger 32 and the anode inlet 14. The connections to the respective heat exchangers remain the same. i.e. the external stream flow path 28 from the external fluid stream 26 remains in fluid connection with the first heat exchanger 30. Likewise, the anode outlet flow path 24 from the anode outlet 20 to the first exhaust 22 is in fluid communication with the second heat exchanger 32.

The change in the order of the first and second heat exchangers 30, 32 allows for a situation where it is preferred to exchange the heat with the external fluid stream 26 and the sweep gas supply 16 after the heat exchange with the anode exhaust gas and the sweep gas supply 16. This can be beneficial where the external fluid stream 26 is high grade heat for instance.

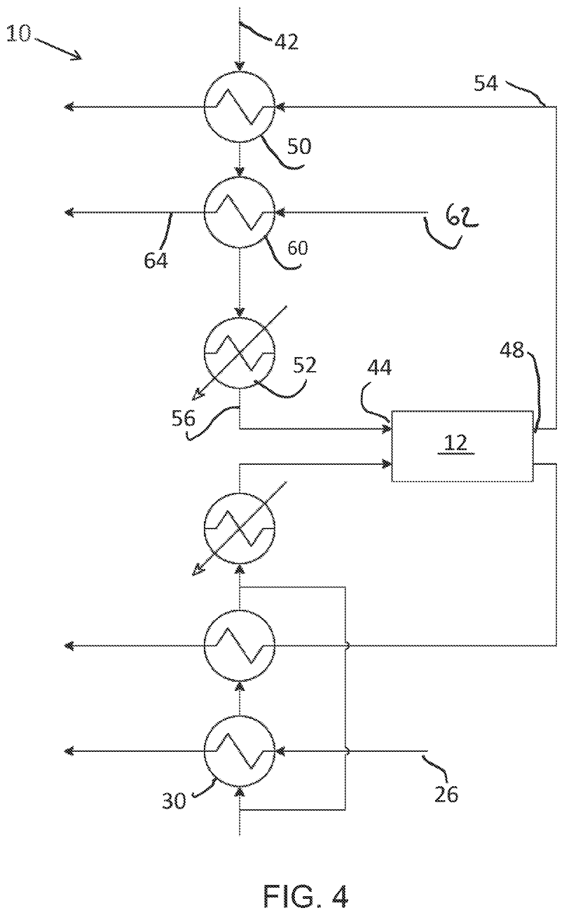

Referring to FIG. 4, there is provided an electrolyser system 10 as shown in FIG. 1. In FIG. 4 a fourth heat exchanger 60 is provided in the fuel supply flow path 56. The fourth heat exchanger 60 is positioned downstream of the third heat exchanger 50, i.e. between the third heat exchanger 50) and the cathode inlet 44 or, where a second heater 52 is provided, between the third heat exchanger 50) and the second heater 52.

The fourth heat exchanger 60 is also in fluid contact with a second external stream flow path 64. The second external stream flow path 64 is a flow path that is produced separate from the process of the electrolyser system 10. The second external stream flow path 64 is provided from a second external fluid stream 62 from a source that is external to the system 10. Whilst the external fluid stream 26 and the second external fluid stream 62 are shown as separate, the streams can be the same. In such a case, the splitting of the flow can take place within the electrolyser system 10, or outside of the system 10.

The second external stream flow path 64 exchanges heat with the fuel supply flow path 56 through the fourth heat exchanger 60. Where the second external fluid stream 62 contains heat energy, this can be transferred in the fourth heat exchanger 60 to provide heat for the fuel supply flow path 56 for feeding into the electrolysis stack 12 through the cathode inlet 44. A higher temperature fuel can assist with the electrolyser reaction. This can be of benefit during start-up when the product in the cathode outlet flow path 54 has no or low heat energy and thus is not as effective to be used to recuperate heat through the third heat exchanger 50.

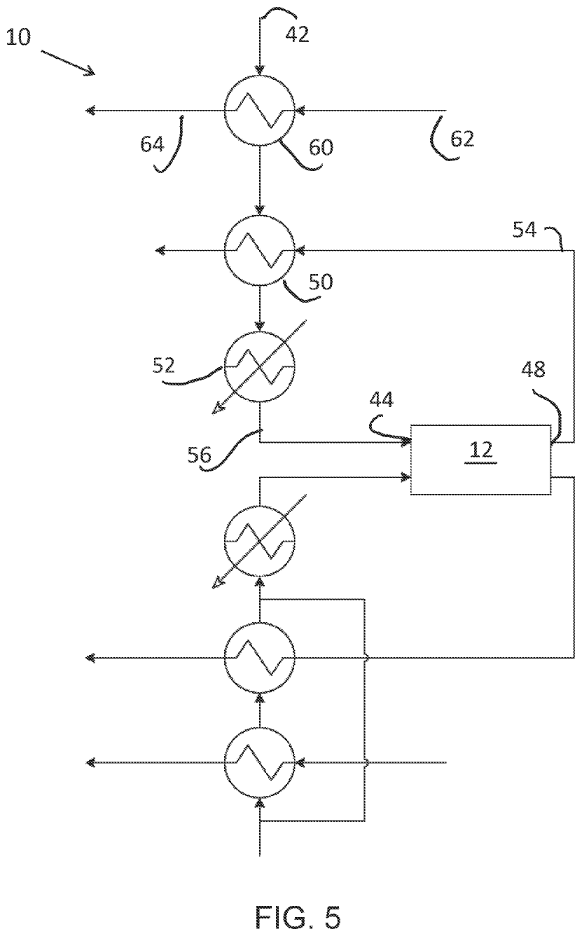

Referring to FIG. 5, there is provided an electrolyser system 10 as shown in FIG. 4. However, in FIG. 5 the fourth heat exchanger 60 is reversed in position with the third heat exchanger 50. Therefore, the fourth heat exchanger 60 is upstream to the third heat exchanger 50) in the fuel supply flow path 56, and the fourth heat exchanger 60 is between the fuel supply 42 and the third heat exchanger 50. Likewise, the third heat exchanger is between the fourth heat exchanger 60) and the cathode inlet 44 in the fuel supply flow path 56 (or the second heater 52, where provided).

The fluid connections of the heat exchangers remain the same, that is to say that the fourth heat exchanger 60 is connected to the second external stream flow path 64 to exchange heat between that and the fuel supply flow path 56. Likewise, the third heat exchanger 50 is connected to the cathode outlet flow path 54 to exchange heat between that and the fuel supply flow path 56.

The reversal of the third and fourth heat exchangers 50, 60 allow the second external fluid stream 62 to be supplied to the fuel supply flow path 56 prior to the heat from the cathode outlet flow path 54. This can be beneficial where the second external fluid stream 62 is of a lower grade heat and it is desirable to exchange this heat before the higher grade heat from the cathode outlet 48 to reduce the temperature exchange in each of the heat exchangers.

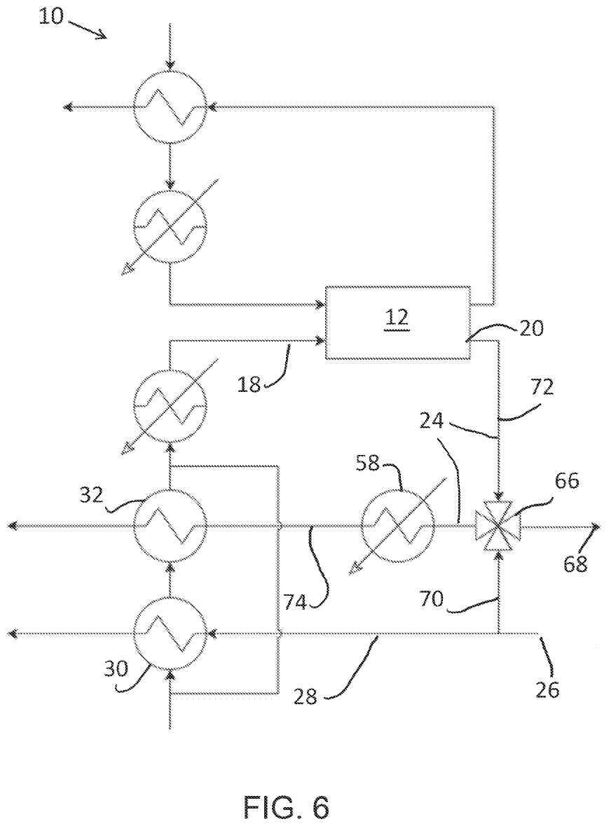

Referring to FIG. 6, there is provided an electrolyser system 10 as shown in FIG. 2. Therefore, the third heater 58 in the anode outlet flow path 24 is provided.

In addition, in FIG. 6, there is provided a diverter valve 66 positioned in the anode outlet flow path 24 and configured to divert flow through the various ports. The diverter valve 66 is positioned in between the anode outlet 20 and the second heat exchanger 32. More particularly, when the third heater 58 is present, the diverter valve 66 is positioned in the anode outlet flow path 24 between the anode outlet 20 and the third heater 58.

The diverter valve 66 has a further connection to the external stream flow path 28. Therefore, the diverter valve 66 can divert flow between the stack section 72 of the anode outlet flow path 24, the burner section 74 of the anode outlet flow path 24, and the external stream flow path 28.

Whilst a number of means can be used to connect the external stream flow path 28 to the diverter valve 66, in one example, a branching line 70 (branching flow path) can be used. The branching line 70 connects from the external stream flow path 70 directly to the diverter valve 66. The branching line 70 can also be referred to as an external stream flow path, branching pipe, extension, or duct.

The diverter valve 66 can also be connected to a further connection. The further connection is a third exhaust 68. Thereby, a flow through the diverter valve 66 can also be directed to the third exhaust 68, wherein the third exhaust 68 is generally a location away from the other components and can be external to the system 10.

The diverter valve 66 can be utilized in number of manners depending on the required operation:
i) In a normal operation of the system 10, such as when the stack 12 has warmed up and is operating at a base load, the diverter valve 66 connects the stack section 72 and the burner section 74 of the anode outlet flow path 24 to form a connection between the anode outlet 20 and second heat exchanger 32. This is of benefit during normal operation where a hot anode exhaust gas can be used to heat the sweep gas supply at the second heat exchanger 32 and therefore functions as a recuperator.

The third heater 58 in this configuration can also be used to provide additional heat energy to the anode outlet flow path 24 either for use in the second heat exchanger, such as during a warm-up phase, or to heat up a back flow to the anode outlet 20 for warming the stack 12.
ii) In a warming operation, the diverter valve 66 can connect the branching line 70 to the stack section 72 of the anode outlet flow path 24. This can use heat from the external fluid stream 26 to heat up the anode outlet 20, including the stack 12 and the anode outlet flow path 24.

In addition or alternatively the diverter valve 66 can connect the branching line 70 to the burner section 74 of the anode outlet flow path 24. This allows the hot flow from the external fluid stream 26 to pass through both heat exchangers and warm the sweep gas supply flow path 18 such as during a start-up or a warm up operation. This mode can also heat from the third heater 58 to heat the external fluid stream 26 and provide a reverse flow for heating the stack section 72 of the anode outlet flow path 24.
iii) In a cool down operation, the diverter valve 66 can connect the stack section 72 of the anode outlet flow path 24 to the third exhaust 68. This can allow the anode exhaust gas from the anode outlet 20 to be vented through the third exhaust 68 without providing any heat exchange in the second heat exchanger 32.

Such a mode of operation can be beneficial where the electrolysis stack 12 is to be cooled down and therefore the recuperation of heat at the second heat exchanger 32 is no longer required. This mode can also be operated when the thermal limits of components would be exceeded by the temperature of the exhaust gas from the anode outlet 20, such as during full operation.

Whilst the diverter valve 66 has been presented with four connection ports, it will be appreciated that the valve can be configured in a number of ways to allow for one or more of the connections depending on the requirements. The diverter valve 66 can be a mechanical or electrical control valve set to a certain value to divert flow in the required direction, or can be manually operated. In some situations, a controller, i.e., including a processor and memory, can be programmed to operate the diverter valve 66 as required.

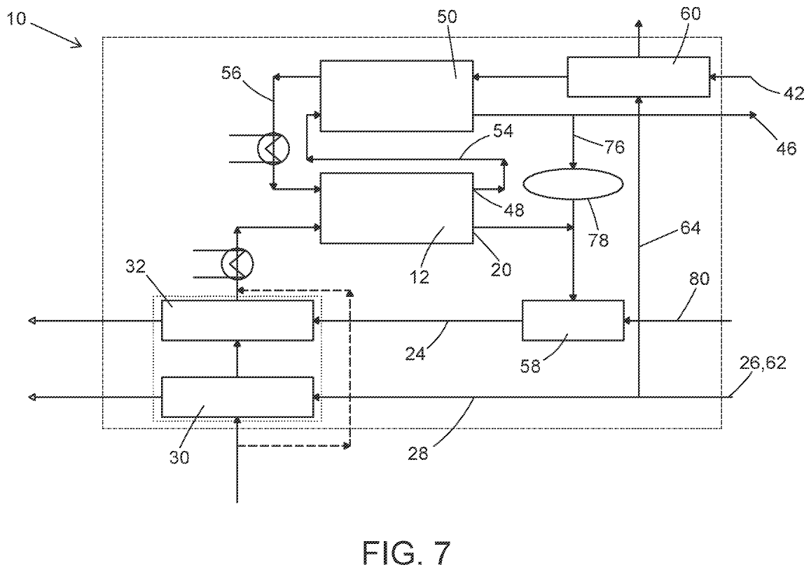

Referring to FIG. 7, there is provided an electrolyser system 10 as shown in FIG. 1 and combining features from the other Figures and as discussed above. For instance, as previously discussed, the external fluid stream 26 and second external fluid stream 62 can be from the same source. Here it is shown that the external fluid streams 26, 62 originate from the same source and then split into the external stream flow path 28 for connection to the first heat exchanger 30 and a second external stream flow path 64 for connection to the fourth heat exchanger 60. Therefore, the first and fourth heat exchangers 30, 60 use the same heat source for transfer with the sweep gas supply and fuel supply respectively.

The third heater 58 is also provided in FIG. 7. However, the burner fuel supply line 80 is provided where the third heater 58 can be fuelled, such as with a combustion burner. It will be appreciated that the third heater 58 may only need the burner fuel supply line 80 to operate during operation when the anode exhaust gas is of a low temperature. The supply line can also be referred to as a burner fuel supply flow path.

A cathode outlet branch flow path 76 (branch flow path 76) is provided in the cathode outlet flow path 54 between the anode outlet 48 and the second exhaust 46. The branch flow path 76 is connected to the anode outlet flow path 24 between the anode outlet 20 and the third heater 58. Therefore, the branch flow path 76 can provide a product (e.g. hydrogen gas) to the anode outlet flow path 24. This branch flow path 76 allows the product from the cathode outlet 48 to be supplied to the third heater 58. Therefore, instead of using the burner fuel supply line 80, the direct product of the electrolysis stack 12 can be used for the third heater 58.

By including the third heater 58 downstream of the stack 12 allows product (e.g. hydrogen) to be bled off from the cathode outlet flow path 54 to raise the sweep gas supply temperature at the second heat exchanger 32 without needing electrical heating. During start up of the system 10, a dedicated stream of hydrogen or other combustible fuel can be supplied from burner fuel supply line 80.

A bleed valve 78 is provided in the branch flow path 76 to control the flow of product from the cathode outlet flow path 54 to the third heater 58 depending on the requirements of the system 10. The bleed valve 78 can be a mechanical or electrical controlled valve set to a certain value to divert flow in the required direction, or can be manually operated. In some situations, a controller. i.e., including a processor and memory, can be programmed to operate the bleed valve 78 as required.

The branch flow path 76 can be positioned anywhere along the cathode outlet flow path 54 and can either be prior to the third heat exchanger 50. i.e. upstream, or between the third heat exchanger 50) and the second exhaust 46. i.e. downstream of the third heat exchanger 50. It is not necessary for the product to have a high temperature where it is being combusted in the third heater 58. Therefore, exchanging heat prior to the branch flow path could be preferable.

Overall, the design of the electrolyser system allows for improved use of heat recovery and exchange during start-up, standard operation and cool down to allow for a more efficient reaction in the electrolysis stack and efficient use of otherwise unutilised heat from the process.

The present invention is not limited to the above embodiments only, and other embodiments will be readily apparent to one of ordinary skill in the art without departing from the scope of the appended claims.

### REFERENCE SIGNS

10 Electrolyser system
12 Electrolysis stack
14 Anode inlet
16 Sweep gas supply
18 Sweep gas supply flow path
20 Anode outlet
22 First exhaust
24 Anode outlet flow path
26 External fluid stream
28 External stream flow path
30 First heat exchanger
32 Second heat exchanger
34 First heater
36 Bypass flow path
38 Bypass first end
40 Bypass second end
42 Fuel supply
44 Cathode inlet
46 Second exhaust
48 Cathode outlet
50 Third heat exchanger
52 Second heater
54 Cathode outlet flow path
56 Fuel supply flow path
58 Third heater
60 Fourth heat exchanger
62 Second external fluid stream
64 Second external stream flow path
66 Diverter valve
68 Third exhaust
70 Branching line
72 Stack section (of the anode outlet flow path)
74 Burner section (of the anode outlet flow path)
76 Cathode outlet branch flow path
78 Bleed valve
80 Burner fuel supply line

1. A solid oxide electrolyser cell system comprising:
an electrolysis stack comprising an anode, a cathode and a solid-oxide electrolyte, the anode comprising an anode inlet,
a sweep gas supply for supplying a sweep gas to the anode via the anode inlet,
a sweep gas supply flow path defining a flow path between the sweep gas supply and the anode inlet,
a first heat exchanger in fluid communication with the sweep gas supply flow path,
wherein the first heat exchanger is also in fluid communication with a fluid stream having a source external to the solid oxide electrolyser cell system and defining an external stream flow path, and
the first heat exchanger is configured to exchange heat between the sweep gas supply flow path and the external stream flow path.

2. The solid oxide electrolyser cell system of claim 1, further comprising a bypass flow path connected to the sweep gas supply flow path, the bypass flow path connected at its first end to a position upstream of the first heat exchanger, and the bypass flow path connected at its second end to a position downstream of the first heat exchanger.

3. The solid oxide electrolyser cell system of claim 1, further comprising a first heater positioned in the sweep gas supply flow path and connected downstream of the first heat exchanger.

4. The solid oxide electrolyser cell system of claim 1, further comprising:
an anode outlet for the anode of the electrolysis stack comprising,
an anode outlet flow path defining a flow path between the anode outlet and a first exhaust, and
a second heat exchanger in fluid communication with the sweep gas supply flow path and positioned downstream of the first heat exchanger in the sweep gas supply flow path, the second heat exchanger also in fluid communication with the anode outlet flow path, wherein the second heat exchanger is configured to exchange heat between the sweep gas supply flow path and the anode outlet flow path.

5. The solid oxide electrolyser cell system of claim 4, further comprising:
a cathode inlet for the cathode of the electrolysis stack,
a fuel supply for supplying fuel to the cathode via the cathode inlet,
a fuel supply flow path defining a flow path between the fuel supply and the cathode inlet,
a cathode outlet for the cathode of the electrolysis stack,
a cathode outlet flow path defining a flow path between the cathode outlet and a second exhaust, and
a third heat exchanger in fluid communication with the fuel supply flow path downstream, the third heat exchanger also in fluid communication with the cathode outlet flow path, and configured to exchange heat between the fuel supply flow path and the cathode outlet flow path.

6. The solid oxide electrolyser cell system of claim 5, further comprising a cathode outlet branch flow path connecting the cathode outlet flow path and the anode outlet flow path placing them in fluid communication.

7. The solid oxide electrolyser cell system of claim 6, further comprising a valve arranged in the cathode outlet branch flow path.

8. The solid oxide electrolyser cell system of claim 4, further comprising:
a fourth heat exchanger in fluid communication with the fuel supply flow path and also in fluid communication the external stream flow path and configured to exchange heat between the flow paths.

9. The solid oxide electrolyser cell system of claim 8, wherein the third heat exchanger is in fluid communication with the fuel supply flow path downstream of the fourth heat exchanger.

10. The solid oxide electrolyser cell system of claim 5, further comprising a second heater positioned in the fuel supply flow path arranged downstream of the third heat exchanger.

11. The solid oxide electrolyser cell system of claim 4, further comprising a third heater positioned in the anode outlet flow path between the anode outlet and the second heat exchanger.

12. The solid oxide electrolyser cell system of claim 4, further comprising a diverter valve connected in the anode outlet flow path at a position between the anode outlet and the second heat exchanger, the diverter valve also connected to the external stream flow path and a third exhaust, the diverter valve configured to direct a flow between the anode outlet and at least one of: the second heat exchanger; external stream flow path; or the third exhaust.

13. A method of operating a solid oxide electrolyser cell system comprising:
providing a sweep gas supply for supplying a sweep gas to an anode of an electrolysis stack via an anode inlet, and defining a sweep gas supply flow path between the sweep gas supply and the anode inlet,
providing a fluid stream having a source external to the solid oxide electrolyser cell system, and defining an external stream flow path from the fluid stream, and
exchanging heat between the external stream flow path and the sweep gas supply flow path through a first heat exchanger.

14. The method of operating a solid oxide electrolyser cell system according to claim 13, wherein there is defined an anode outlet flow path between an anode outlet of the anode of the electrolyser and a first exhaust to the system.

15. The method of operating a solid oxide electrolyser cell system according to claim 14, comprising:
exchanging heat between the anode outlet flow path and the sweep gas supply flow path by a second heat exchanger, the second heat exchanger arranged in the sweep gas supply flow path at a position downstream of the first heat exchanger.

16. The method of operating a solid oxide electrolyser cell system according to claim 15, comprising bypassing the first and second heat exchangers by a bypass flow path arranged in the sweep gas supply flow path upstream of the first heat exchanger and downstream of the second heat exchanger.

17. A method of operating a solid oxide electrolyser cell system according to claim 15, comprising providing heat to the anode outlet flow path from a third heater arranged in the anode outlet flow path between the anode outlet and second heat exchanger.

18. A method of operating of operating a solid oxide electrolyser cell system according to claim 17, comprising providing heat to the anode outlet flow path from the external fluid flow path or the third heater by a diverter valve arranged in the flow paths between the anode outlet and the burner.
